(19) United States
(12) Patent Application Publication
(10) Pub. No.: US 2003/0044630 A1
(43) Pub. Date: Mar. 6, 2003

(54) Plaster-based prefabricated structural element and in particular a plaster-based board having improved fire resistance

(76) Inventor: Claude Leclercq, Pernes Les Fontaines (FR)

Correspondence Address: BURNS DOANE SWECKER & MATHIS L L P, POST OFFICE BOX 1404, ALEXANDRIA, VA, 22313-1404, US

(21) Appl. No.: 09/501,767

(22) Filed: Feb. 10, 2000

(30) Foreign Application Priority Data
Feb. 12, 1999 (FR) 9901883

(51) Int. Cl. C09D 5/16

(52) U.S. Cl. 428/537.7; 428/688; 106/18.12

(57) ABSTRACT

Fire-resistant prefabricated structural element having a relatively small average thickness, comprising a substrate based on cured plaster, said substrate being able to be obtained by hydration, for example mixing, of dry matter comprising mostly at least a hydratable calcium sulfate, and a mineral additive in discrete form, comprising a clayey material, characterized in that the mineral additive essentially comprises a clayey material, the quantity of crystalline silica of which is at most equal to approximately 15% by weight of said mineral additive, and an inert mineral supplement compatible with the clayey material and dispersible in the cured-plaster substrate.

The present invention relates to fire-resistant prefabricated structural elements comprising a substrate based on cured and dry plaster. More particularly, the invention relates to prefabricated structural elements having a relatively small average thickness, for example from one to several centimeters, in a preferred direction or dimension, with a limited mass per unit area, for example about ten kg/m². By way of preferred, but nonlimiting, example, reference will be made to elements either of the type comprising a plasterboard coated with a reinforcing sheet on each face, for example a cardboard sheet or a mat of mineral fibers (for example glass fibers), or of the type comprising a fibrous board in which the plaster contains, throughout the mass, homogeneously dispersed fibers (for example cellulose fibers), and which is commonly called “GFB” (Gypsum Fiber Board).

The expression “fire resistance” should be understood to mean the ability of such a prefabricated structural element to create a fire barrier, this ability extending from at least any one of the following properties:

the dimensional stability of said element after exposure to high temperature for a predetermined period of time;

the mechanical integrity of said element at high temperature;

the thermal insulation provided by said element at high temperature.

Depending on the countries, this fire resistance is codified or regulated by specific standards. Thus, in the Federal Republic of Germany, in the case of so-called GKF boards, the two surfaces of the plaster-based substrate of which are each coated with a reinforcing sheet comprising cellulose fibers in the entangled state, for example a cardboard sheet, reference should be made to the DIN 18180 standard (the September 1989 version) and to the DIN 4102 (part IV) standard (the March 1994 version) relating to wall-lining or partition systems comprising such boards.

These two standards require, in particular, plaster specimens to be tested in tension at temperatures of approximately 850° C. for approximately 30 minutes or 1 hour. The Applicant uses these test under most stringent conditions, namely a temperature of 970° C. or 1020° C. for approximately 1 hour, and determines the cohesion and shrinkage of the test pieces under these conditions. With regard to the mechanical integrity, this must remain for longer than ½ hour; and with regard to the dimensional stability, the shrinkage must be as small as possible, for example about 4%, measured in the cooled state.

At the present time, to the Applicant's best knowledge, it is not known how to manufacture GFB boards having the fire resistance of so-called GKF boards.

Document U.S. Pat. No. 3,616,173 has described and proposed a prefabricated structural element, of the type defined above (small thickness with a limited mass per unit area), in this case a plasterboard coated with a cardboard sheet on each of the faces of the cured-plaster substrate. The latter can be obtained by hydration, for example by mixing a dry substance comprising, by weight, at least:

mostly, i.e. about 71.5 to 99%, a hydratable calcium sulfate (CaSO₄.½H₂O);

glass fibers, about 0.1 to 1%;

a mineral additive comprising a clayey material, colloidal silica and aluminum oxide, or a mixture of at least two of these compounds; this mineral additive represents a proportion of about 0.5 to 20%.

Such boards have a limited mechanical integrity in a fire.

Document EP 0,409,914, in the name of the Applicant, has described and proposed cured-plaster boards which are not only fire resistant but have the ability not to propagate the fire. According to that document, the cured-plaster substrate is coated on both its faces with a glass mat. Furthermore, incorporated into the cured-plaster substrate is a mineral additive based on crystallized silica, talc and mica.

Moreover, it is recognized that any crystalline silica, as a mineral filler, has beneficial effects with regard to any cured-plaster substrate exposed to fire. In particular, a crystalline silica, for example a quartz, has an expansion plateau around 600° C., which compensates as it were for the actual shrinkage of the plaster.

Be that as it may, the handling of crystalline silica (SiO₂) in powder form, which may in particular comprise small-sized particles, for example less than 5 microns, appears to be difficult and tricky under the conditions and the environment of any industrial manufacture.

The object of the present invention is to improve the fire resistance of structural elements as defined above, and in particular of so-called GFB fibrous boards or plasterboards coated with cardboard, in order to raise their fire performance to the highest level known at the present time, namely GKF, according to the previously identified standards DIN 18180 and 4102 (part IV), and this being so by limiting the proportion of silica in the plaster substrate.

In accordance with the present invention, when a mineral additive comprising a clayey material is used to increase the fire resistance, it has been discovered that the proportion by weight of mineral silica in said additive could be reduced to 15% without affecting the fire resistance of the structural element in which said additive is incorporated and distributed, provided that the additive is supplemented with an inert mineral material compatible with the clayey material and dispersible in the cured-plaster substrate.

Consequently, according to the invention, the mineral additive essentially comprises a clayey material, the quantity of crystalline silica of which is at most equal to approximately 15% by weight of said mineral additive, and an inert mineral supplement compatible with the clayey material and dispersible in the cured-plaster substrate.

By virtue of the present invention, with regard for example to so-called GFB fibrous boards or plasterboards coated with cardboard, the proportion by weight of the mineral additive is such that the latter gives the structural element a fire resistance identical to that of a so-called GKF board, defined by the German standards DIN 18180 and 4102 (part IV), in particular a shrinkage not exceeding 4%.

In addition, the solution according to the invention does not substantially modify the various processes known at the present time for manufacturing these structural elements, in which:

a) the plasterboards are obtained by casting a plaster-based slurry between two cardboard sheets or two fiberglass mats;

b) a slurry based on cellulose fibers and plaster is filtered using a papermaking-type process in order to obtain so-called GFB boards;

c) a mixture of plaster, cellulose fibers and water is spread and compressed in a semi-wet or semi-dry process, again in order to obtain so-called GFB boards.

Furthermore, the solution according to the invention also makes it possible to retain the in-use properties of these prefabricated structural elements, for example their “screwability”, that is to say their ability to withstand fastening screws being mounted without the cohesion of the substrate being destroyed.

The present invention also comprises the following secondary features:

the inert mineral supplement is preferably dolomite;

the clayey material includes an illite and/or kaolin;

mineral fibers compatible with the hydratable calcium sulfate, for example glass fibers, are distributed in the cured-plaster substrate in a proportion by weight of dry matter of less than 1%;

the mineral additive is dispersed in the cured-plaster-based substrate, with a particle size distribution such that the particles having a size of less than or equal to 63 μm represent a proportion by weight of at least 85% of said mineral additive;

the mineral additive comprises, in approximately equal proportions by weight, the clayey material incorporating the silica, and the inert mineral supplement;

the mineral additive represents a proportion by weight of dry matter introduced of at least 5% and preferably at least 10%;

the structural element can be obtained using a process chosen from the group consisting of any process for manufacturing GFB fibrous boards, of the papermaking type, any process of the type with so-called semi-wet or semi-dry compression, and any process for manufacturing plasterboards by casting a plaster slurry between two cardboard sheets (or a mat of mineral fibers, for example glass fibers).

Throughout the description below, the term “cured plaster” will be reserved for calcium sulfate dihydrate (CaSO₄.2H₂O).

The term “hydratable calcium sulfate” should be understood to mean a mineral compound or composition consisting of or comprising an anhydrous calcium sulfate (anhydrite II or III) or a calcium sulfate hemihydrate (CaSO₄.½H₂O), whatever the crystalline form, α or β, of the latter. Such a compound is generally obtained by curing a natural gypsum or a reconstituted gypsum, for example sulfogypsum.

The term “cellulose fibers” should be understood to mean discrete elements, such as fibers, filaments and chips, based on natural, regenerated, recycled or modified cellulose; preferably, the cellulose fibers in question are those generally used in the composition of papers and boards.

The term “mineral fibers” should be understood to mean inorganic fibers, for example glass fibers. It is also possible to use alumino silicate ceramic inorganic fibers such as those used for the insulation of thermal ovens.

In accordance with Table 1, two compositions, called (X) and (Y) respectively, of a mineral additive according to the present invention are described. The additive (X) is that employed in accordance with Examples 1.1 and 1.2 below.

TABLE 1

| | Composition X | Composition Y |
|---|---|---|
| Mineralogical composition | | |
| kaolin | 25 | 25 |
| illite | 10 | 10 |
| quartz | 15 | 15 |
| dolomite | 50 | 50 |
| Calcined chemical composition | | |
| (%) | | |
| SiO₂ | 43 | 35 |
| TiO₂ | 1.1 | 0.9 |
| Al₂O₃ | 15 | 13 |
| Fe₂O₃ | 1.6 | 1.3 |
| K₂O | 1.2 | 1.1 |
| CaO | 23 | 30 |
| MgO | 14 | 18 |
| Particle size distribution | | |
| 63 μm screen oversize | <15% | <10% |
| 200 μm screen oversize | | <1% |
| Loss on ignition at 900% [sic] | 26.5% | 22.6% |

In accordance with the present invention, the mineral additive furthermore has the following chemical composition characteristics:

its silica content by weight is between 30 and 50% and preferably between 35 and 40%;

its CaO content by weight is between 20 and 35% and preferably between 20 and 30%;

its MgO content by weight is between 10 and 25% and preferably between 10 and 20%.

### EXAMPLES

1/1 Manufacture of GFB Fiberboards by a Papermaking Process, by Filtration by Compression, with a Large Amount of Water Introduced at the Start (the Ratio by Weight of Water to Hydratable Calcium Sulfate is Between 300 and 800%).

The board is manufactured by the following successive steps:

Preparation of a pulp by mixing 8 liters of water (from a tap, or water coming from recycling the filtrate of boards) with 273 g of newsprint or of regenerated-cellulose fibers, and then pulping with a RAYNERI® mixer, model Turbotest 207370, for 20 minutes at speed 6 and then for 25 minutes at speed 10.

Weighing a quantity of pulp in the bowl of a Hobart® apparatus, model N-50G.

Introduction into the pulp of a quantity of Vetrotex® E518 22 glass fibers.

Weighing, in a separate container, a quantity of hydratable calcium sulfate (CaSO₄.½H₂O) obtained by curing a gypsum coming from flue-gas desulfurization.

Introduction, into said separate container, of the weighed hydratable calcium sulfate and mixing, by a suitable mechanical means, of a quantity of mineral additive of formula (X).

Introduction, into the Hobart apparatus, of the hydratable calcium sulfate to which the above additive has thus been added and mixing at speed 1 for 15 seconds, with an N5B NSF blade, scraping for 15 seconds and mixing at speed 1 for 90 seconds.

Deposition of the slurry thus obtained in a mold provided with a permeable filter cloth, having the dimensions 25.5×25.5 cm² or 60×40 cm² depending on the size of the desired [sic] of the board.

Pressing with a press until a cake approximately 12.5 mm in thickness is obtained.

Application of the pressure for at least 20 seconds in order to remove the water through the filter cloths, which are identical to those of industrial equipment.

Demolding.

Holding at room temperature until complete hydration of the calcium sulfate.

Drying with a suitable temperature profile, without calcining the cured plaster.

Table 2 below summarizes, for seven [sic] tests, the characteristics of the boards thus obtained, having a thickness of approximately 12.5 mm, which are manufactured with this protocol in a mold having the dimensions 25.5×25.5 cm².

The fire withstand time, in minutes, of the test piece and the percentage shrinkage of the test piece are measured under conditions of the DIN 18180 and DIN 4102 standards.

The same applies to the shrinkage of the test piece, expressed as a percentage, in the cooled state.

TABLE 2

| | | Results | |
|---|---|---|---|
| Hydratable | Water | Duration | Shrinkage |

| | Cellulose | | | | Mineral | | calcium | | Total dry | | Water/ | of the | of the test |
|---|---|---|---|---|---|---|---|---|---|---|---|---|---|
| | fibers | | Glass fibers | | additive | | sulfate | | weight | | dry | test piece | piece |
| Test | (g) | (%) | (g) | (%) | (g) | (%) | (g) | (%) | (g) | (g) | weight | (min) | (%) |
| 1 | 68 | 7.6 | 3.5 | 0.4 | 160 | 18 | 666 | 74 | 897.5 | 1931 | 2.2 | >60 | 4.2 |
| 2 | 82 | 8.5 | 3.5 | 0.4 | 80 | 8.3 | 800 | 83 | 965.5 | 2318 | 2.4 | >60 | 6.3 |
| 3 | 82 | 8.5 | 3.5 | 0.4 | 80 | 8.3 | 800 | 83 | 965.5 | 2318 | 2.4 | >60 | 6.4 |
| 4 | 75 | 8.4 | 3.5 | 0.4 | 80 | 9 | 733 | 82 | 891.5 | 2125 | 2.4 | >60 | 6.4 |
| 5 | 82 | 9.2 | 3.5 | 0.4 | — | — | 800 | 90 | 885.5 | 2318 | 2.6 | >60 | 10 |
| 6 | 95 | 10.5 | — | — | 80 | 8.8 | 733 | 81 | 908 | 2704 | 3 | >60 | 6.2 |

Unless mentioned otherwise, all the percentages are expressed as percentages by weight with respect to the total weight of the dry matter introduced.

The final test 7 is a control test: the board is produced without the mineral additive and without glass fibers. Without the mineral additive according to the invention, the shrinkage of the test piece is very large.

The fifth test corresponds to a board produced without the mineral additive, but with glass fibers. The latter do not allow the shrinkage of the test piece to be reduced.

The other tests, carried out with the mineral additive, show that the shrinkage is significantly reduced, even without the addition of glass fibers (cf. sixth test).

1/2 Manufacture of GFB-Type Fiberboards by Compression Using the Semi-Wet or Semi-Dry Process

The board is manufactured after:

Preparation of a paper fluff by grinding newsprint in a PALLMAN® apparatus, of type PMKS 460/8, with a 2 mm screen.

Weighing of a quantity of fluff and introduction into a LODIGE® mixer, of type M20G.RE.

Weighing, in a separate container, a quantity of hydratable calcium sulfate (CaSO₄.½H₂O) obtained by curing a dihydrate coming from flue-gas desulfurization.

Introduction of a quantity of mineral additive of formula (X) into this hydratable calcium sulfate and mixing by a suitable mechanical means.

Introduction of a quantity of Vetrotex® E518 22 glass fibers into the hydratable calcium sulfate, to which the additive has been added, thus obtained.

Introduction of the above mixture, containing the fibers (fluff), into the LODIGE® mixer, of type M20G.RE, and mixing for 30 minutes.

Depositing the final mixture in a mold of dimensions 25.5×25.5 cm² or 60×40 cm², depending on the desired size of the board, and watering with approximately the same quantity of water (water/solid ratio of approximately 0.5).

Pressing until a cake 12.5 mm in thickness is obtained.

Application of the pressure for at least 20 seconds in order to remove the excess water and the air through the draining cloth which is located in the bottom of the filter and which is identical to that of industrial equipment.

Demolding.

Holding at room temperature until complete hydration of the calcium sulfate.

Drying with a suitable temperature profile in order to remove the water without calcining the cured plaster.

Table 3 below summarizes, for two tests, the characteristics of the boards having a thickness of approximately 12.5 mm, which are manufactured with this protocol in a mold of dimensions 25.5×25.5 cm² and under the same test conditions described in the DIN 18180 and DIN 4102 standards.

TABLE 3

| | | | | | | | | | | | | Results | |
|---|---|---|---|---|---|---|---|---|---|---|---|---|---|
| | | | | | | | Hydratable | | | Water | | Duration | Shrinkage |
| | Cellulose | | | | Mineral | | calcium | | Total dry | | Water/ | of the | of the test |
| | fibers | | Glass fibers | | additive | | sulfate | | weight | | dry | test piece | piece |
| Test | (g) | (%) | (g) | (%) | (g) | (%) | (g) | (%) | (g) | (g) | weight | (min) | (%) |
| | 133 | 14 | 3.5 | 0.4 | 80 | 8.3 | 750 | 77.5 | 966.5 | 300 | 0.3 | >60 | 4.6 |
| | 133 | 15 | — | — | — | — | 750 | 85 | 883 | 300 | 0.4 | 30 | 9 |

Table 3 above shows that, when the test piece is produced with the mineral additive according to the invention, it breaks after 30 minutes. The shrinkage measured at that moment reaches 9%.

2/1 Comparative Tests on Test Pieces Obtained in the Laboratory and in an Industrial Production Line, for Cardboard-Covered Plasterboards Obtained by a Process in Which the Plaster Slurry is Cast Between Two Cardboard Sheets.

Table 4 defines various tests, carried out so as to make a comparison between conventional mineral fillers and the mineral additive according to the present invention. In this table:

“quartz C400” means fine crystalline silica sold by the company SIFRACO;

“kaolin K13” means a finished [sic] kaolinic silicate sold by the company SIKA;

dolomite from the company LHOIST, having a particle size greater than 200 microns.

The term “plasterboard” should be understood to mean boards whose cured-plaster substrate has a thickness of 12.5 mm and is coated on both sides with cardboard sheets, bonded to the plaster, having the following characteristics:

thickness of the cardboard sheets: approximately 0.3 mm;

mass per unit area of the board: approximately 10.5 kg/mm².

The plaster used was obtained by curing a sulfogypsum.

TABLE 4
Fire shrinkage of plasterboards

| | | | | | Shrinkage |
|---|---|---|---|---|---|
| | | Mineral additive | | Board | at 1020° C. |
| Test | Type of | | Quantity | weight | for 90 |
| No. | board | Type | (g/m²) | (kg/m²) | min |
| 1 | Laboratory | | | 10 | 13 |
| | strips | | | | |
| 2 | Laboratory | | | 10.4 | 12 |
| | strips | | | | |
| 3 | Laboratory | Quartz C400 | 450 | 10.3 | 5.4 |
| | miniboards | | | | |
| 4 | Laboratory | Composition X | 1000 | 10.4 | 3.7 |
| | miniboards | | | | |
| 5 | Laboratory | Dolomite | 1000 | 10.6 | 9.6 |
| | miniboards | | | | |
| 6 | Laboratory | Kaolin + | 900 | 10.4 | 3.5 |
| | miniboards | Dolomite | | | |
| 7 | Industrial | Quartz C400 | 450 | 10.4 | 6.2 |
| 8 | Industrial | Composition X | 900 | 10.3 | 3.6 |
| 9 | Industrial | Composition X | 1200 | 10.2 | 3.2 |
| 10 | Industrial | Composition X | 700 | 10 | 4.4 |

Tests 1 and 2 are control tests.

It is found that the various mineral additions, other than the mineral additive according to the present invention, improve the fire shrinkage. However, the best results are obtained with a mineral additive according to the invention, and make it possible to achieve the fire-resistance performance of so-called “GKF” boards.

Dolomite by itself, especially cf. Test No. 6, does not have a very favorable effect on the shrinkage.

2/2 Comparative Fire-Resistance Tests, According to the So-Called GKF Board Standards, on Test Pieces of Cardboard-Covered Plasterboards Manufactured on an Industrial Line and Containing the Mineral Additive According to the Invention and Glass Fibers.

TABLE 5

| | Glass | Mineral | | | | | | |
|---|---|---|---|---|---|---|---|---|
| Test | fibers | additive Y | Weight | Relative | | | | |
| No. | (g/m²) | (g/m²) | (kg/m²) | density | (1) | (2) | (3) | (4) |
| 1 | 30 | 750 | 11.2 | 0.91 | 2.8 | 2.1 | 3.4 | 3.9 |
| 2 | 30 | 750 | 11.2 | 0.91 | 3.55 | 1.1 | 3.8 | 3.15 |
| 3 | 30 | 750 | 11.2 | 0.91 | 2 | 1.8 | 4.2 | 2.6 |
| 4 | 30 | 800 | 11.4 | 0.93 | 2.6 | 1.6 | 2.6 | 2.4 |
| 5 | 30 | 800 | 11.4 | 0.93 | 1.8 | 1.8 | 2.8 | 2.6 |
| 6 | 30 | 800 | 11.4 | 0.93 | 1.2 | 1.8 | 2.4 | 2.2 |

(1): shrinkage in the longitudinal direction after 60 minutes of the 970° C. fire test with a tensile stress of 0.16 kg/cm²;

(2): shrinkage in the transverse direction after 30 minutes of the 970° C. fire test with a tensile stress of 0.16 kg/cm²;

(3): shrinkage in the longitudinal direction after 60 minutes of the 1020° C. fire test with a tensile stress of 0.16 kg/cm²;

(4): shrinkage in the transverse direction after 30 minutes of the 1020° C. fire test with a tensile stress of 0.16 kg/cm².

It is found that the shrinkage of the test pieces produced with the mineral additive according to the invention is small, namely less than 4%.

1) Fire-resistant prefabricated structural element having a relatively small average thickness, comprising a substrate based on cured plaster, said substrate being able to be obtained by hydration, for example mixing, of dry matter comprising mostly at least a hydratable calcium sulfate, and a mineral additive in discrete form, comprising a clayey material, characterized in that the mineral additive essentially comprises a clayey material, the quantity of crystalline silica of which is at most equal to approximately 15% by weight of said mineral additive, and an inert mineral supplement compatible with the clayey material and dispersible in the cured-plaster substrate.

2) Element according to claim 1, characterized in that the proportion by weight of the mineral additive is such that the latter gives said structural element a fire resistance identical to that of a so-called GKF board, defined by the German standards DIN 18180 and 4102 (part IV), in particular a shrinkage not exceeding 4%.

3) Element according to claim 1, characterized in that the inert mineral supplement is dolomite.

4) Element according to claim 1, characterized in that the clayey material includes an illite and/or kaolin.

5) Element according to claim 1, characterized in that the two faces of a cured-plaster board are each coated with a mat of mineral fibers, for example glass fibers.

6) Element according to claim 1, characterized in that mineral fibers compatible with the hydratable calcium sulfate, for example glass fibers, are distributed in the cured-plaster substrate in a proportion by weight of dry matter of less than 1%.

7) Element according to claim 1, characterized in that the two surfaces of the cured-plaster substrate are each coated with a cardboard sheet bonded to the substrate.

8) Element according to claim 1, characterized in that the mineral additive is dispersed in the cured-plaster-based substrate with a particle size distribution such that the particles having a size of less than or equal to 63 μm represent a proportion by weight of at least 85% of said mineral additive.

9) Element according to claim 1, characterized in that the mineral additive comprises, in approximately equal proportions by weight, the clayey material incorporating the silica and the inert mineral supplement.

10) Element according to claim 1, characterized in that the mineral additive represents a proportion by weight of the dry matter introduced of at least 5% and preferably at least 10%.

11) Structural element according to any one of claims 1 to 10, characterized in that it can be obtained using a process chosen from the group consisting of any process for manufacturing GFB fibrous boards, of the papermaking type, any process of the type with so-called semi-wet or semi-dry compression and any process for manufacturing plasterboards by casting a plaster slurry between two cardboard sheets or mat of mineral fibers.

12) Mineral additive in discrete form, comprising a clayey material, characterized in that the mineral additive in powder form essentially comprises a clayey material, the quantity of crystalline silica of which is at most approximately 15% by weight of said mineral additive, and an inert mineral supplement, for example based on dolomite, compatible with the clayey material and dispersible in any cured-plaster substrate.

13) Use of an additive according to claim 12 for the manufacture of a structural element comprising a plaster-based substrate.
